(19) United States
(12) Patent Application Publication
(10) Pub. No.: US 2017/0150140 A1
(43) Pub. Date: May 25, 2017

(54) MEASURING MEDIA STREAM SWITCHING BASED ON BARCODE IMAGES

(71) Applicant: Rohde & Schwarz GmbH & Co. KG, Munich (DE)

(72) Inventor: Christoph NUFER, Munich (DE)

(21) Appl. No.: 14/949,789

(22) Filed: Nov. 23, 2015

(51) Int. Cl. H04N 17/00; H04N 21/442; H04N 21/439; H04N 21/2343; H04N 21/44

(52) U.S. Cl. CPC H04N 17/004; H04N 21/23439; H04N 21/44008; H04N 21/4394; H04N 21/4424

(57) ABSTRACT

A measurement system is provided for measuring a change, of a device under test, between a first video sequence having a first video quality and a second video sequence having a second video quality. The measurement system comprises a video signal source configured to provide the first video sequence and the second video sequence, wherein the first video sequence is identified by a first identification indicator and the second video sequence is identified by a second identification indicator. The measurement system further comprises a detecting device configured to detect a change from the first video sequence to the second video sequence based on a difference between the first identification indicator and the second identification indicator.

### FIELD

The present invention relates to a measuring system and method for measuring media stream switching based on barcode images.

### BACKGROUND

Currently, there are no measuring systems or methods available that can be used for the purpose of measuring media stream switching with the aid of identification patterns. In fact, existing measuring systems and methods aim at measuring the quality of a compressed video or the quality of a video transmission or the video processing quality.

The publication WO 2014/175823 A1, for example, describes a measuring system for measuring video processing quality of a device under test. For this purpose, the device under test (which includes a display) is set up for receiving and displaying a video that comprises at least a first barcode to be displayed for a first duration. The measuring system includes a barcode reader that is set up for reading the first barcode form the display of the device under test, and then for determining the video processing quality of the device under test based upon measuring results of the barcode reader.

What is needed, therefore, are approaches (e.g., measuring devices or systems and measuring methods) that provide for improved measurement of the media stream switching of a device under test.

### SUMMARY

Embodiments of the present invention advantageously address the foregoing requirements and needs, as well as others, by providing approaches for such a measuring device and measuring method. By way of example, such approaches provide for the measurement of FMCW signals, with the reconstruction and display of an ideal measurement signal alongside the actual measurement signal, which facilitates efficient identification of whether the characterizing parameter has been correctly automatically detected.

In accordance with example embodiments of the present invention, a measurement system is provided for measuring a change, of a device under test, between a first video sequence having a first video quality and a second video sequence having a second video quality. The measurement system comprises a video signal source configured to provide the first video sequence and the second video sequence, wherein the first video sequence is identified by a first identification indicator and the second video sequence is identified by a second identification indicator. The measurement system further comprises a detecting device configured to detect a change from the first video sequence to the second video sequence based on a difference between the first identification indicator and the second identification indicator.

By way of example, each of the first and second identification indicators is one of an optical pattern and an acoustical pattern. The acoustical pattern allows, apart from the measurement of media stream switching, further useful measurements like the synchronization between image and sound of a video sequence. By way of further example, the optical pattern is one of a bar code and a QR-code, and the acoustic pattern is a sound sequence. Bar codes and QR codes are standardized and widespread. By way of further example, the detecting device comprises one of a camera and a microphone. Using such standard components makes the measuring systems easy to manufacture and to use, and the use of standard components allows for cost-effectiveness of the measuring system. By way of further example, the detecting device comprises one of a bar code scanner and a QR-code scanner. Also for the above-mentioned reasons of simple structure, easy handling and cost-effectiveness. By way of further example, the first video sequence and the second video sequence are different media streams, wherein the different media streams are versions of a same video content that differ in at least one technical aspect. This allows for accurate detection of seamless switching between the different media streams. By way of further example, the video signal source comprises a display of the device under test, and wherein the detecting device comprises one of at least one mirror, and a light guide configured to reflect or guide an image or frame from the display of the device under test to a camera of the device under test. Such a structure would facilitate measurements internally on the device under test without using external hardware.

In accordance with further example embodiments of the present invention, a measurement method is provided for measuring a change, of a device under test, between a first video sequence having a first video quality and a second video sequence having a second video quality. The method comprises providing, by a video signal source, the first video sequence and the second video sequence, wherein the first video sequence is identified by a first identification indicator and the second video sequence is identified by a second identification indicator. The method further comprises detecting a change from the first video sequence to the second video sequence based on a difference between the first identification indicator and the second identification indicator. By way of example, each of the first and second identification indicators is one of an optical pattern and an acoustical pattern. By way of further example, the optical pattern is one of a bar code and a QR-code, and the acoustic pattern is a sound sequence. By way of further example, the first video sequence and the second video sequence are provided by a display of the device under test, wherein an image or frame of the display is reflected or guided from the display to a camera of the device under test. By way of further example, the first video sequence and the second video sequence are different media streams, wherein the different media streams are versions of a same video content that differ in at least one technical aspect. By way of further example, a video quality is altered based on the change from the first video sequence to the second video sequence, and wherein a time delay between the altering of the video quality and a reaction of the device under test is measured. This provides one example of many useful measurement use cases.

In accordance with yet further example embodiments of the present invention, a measurement system is provided comprising a device under test comprising an optical display and an optical detector, and at least one mirror or light guide configured to reflect or guide an image or frame from the optical display to the optical detector. By way of example, the optical detector comprises a camera. In many cases, it can be assumed that the typical device under test has already an integrated camera, and thus there is no additional hardware requirement for the optical detector. By way of further example, the light guide comprises an optical wave guide. In this context, there is no limitation regarding the type of the optical wave guide, where two typical examples of optical wave guides include glass fiber and polymer optical fiber (POF). By way of further example, the light guide further comprises a first lens that focuses the image or frame from the optical display to a first end of the optical wave guide, and a second lens that focuses the image or frame from a second end of the optical wave guide to the optical detector. By way of further example, the image or frame comprises a predefined test pattern.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings, in which like reference numerals refer to similar elements, and in which:

FIG. 1 shows an overview of the measuring of media stream switching, in accordance with example embodiments;

FIG. 2 shows a measuring system where a display and camera of the device under test arranged opposite from each other, in accordance with example embodiments;

FIG. 3 shows a measuring system where a display and camera of the device under test are arranged adjacent to each other, in accordance with example embodiments;

FIG. 4 shows a further measuring system where a display and camera of the device under test are arranged opposite from each other, in accordance with example embodiments;

FIG. 5 shows a further measuring system where a display and camera of the device under test are arranged adjacent to each other, in accordance with example embodiments;

FIG. 6 shows the correlation between device under test sided video quality and radio frequency impairments, and illustrates switching delay; and

FIG. 7 shows a flow chart of a measurement method, in accordance with example embodiments.

### DETAILED DESCRIPTION

Novel approaches (e.g., measuring devices or systems and measuring methods) that provide for improved measurement of the media stream switching of a device under test, are provided. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

For the purposes hereof, a media stream consists of an information stream comprising any kind of optical and/or acoustical information. Media streams may include different technical versions of the same audio and/or video content, and typically differ regarding video bit rate, audio bit rate, video resolution etc. Different media streams may be synchronized to each other in order to allow seamless switching between them. Further, the terms “media stream” and “video sequence” are used interchangeably in the present specification.

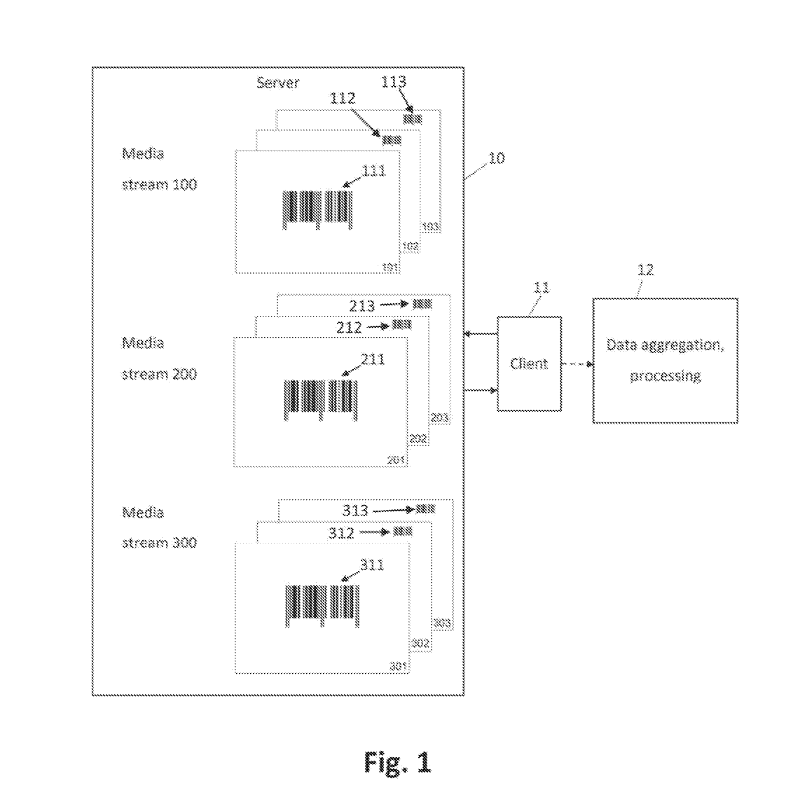

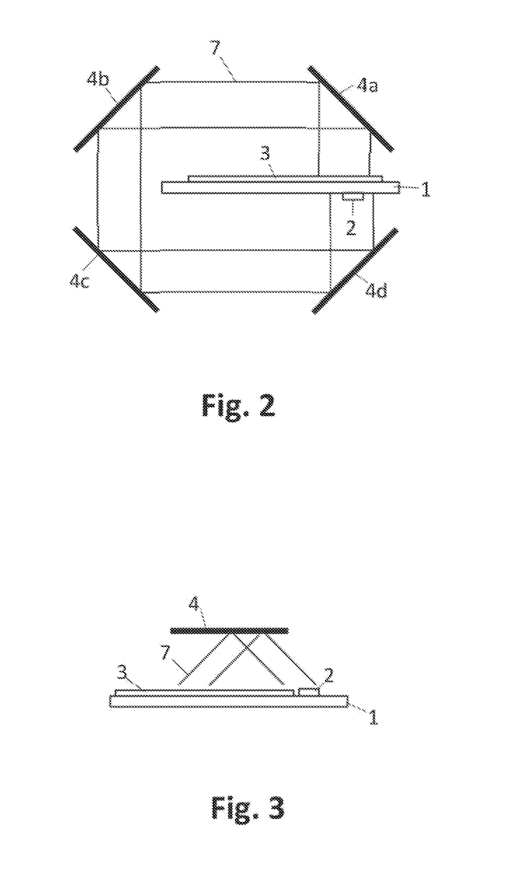

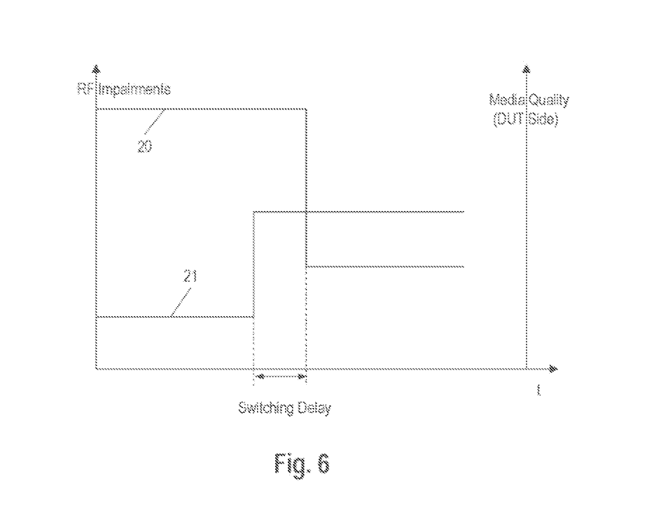

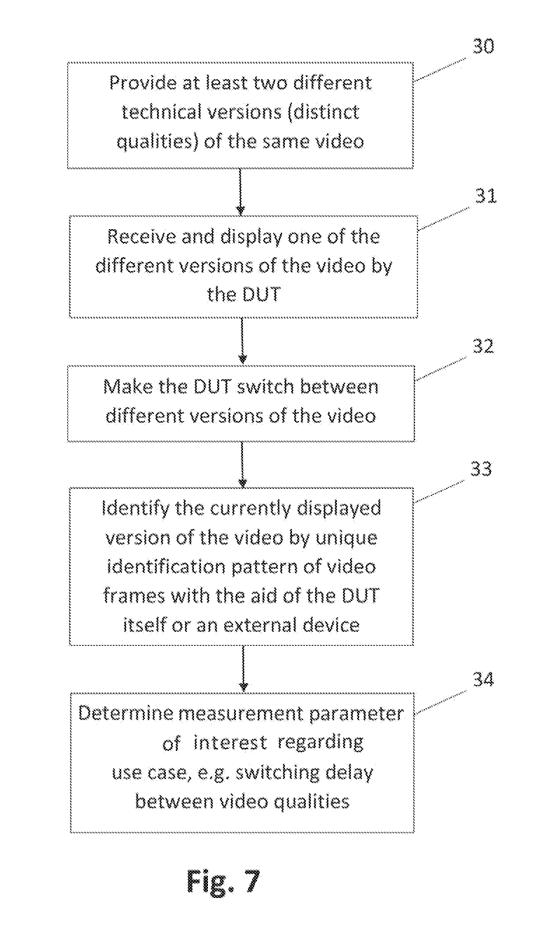

At first, an overview diagram shown in FIG. 1 is given in order to illustrate the basic idea of measuring media stream switching. With the aid of FIGS. 2 to 5 we will then demonstrate four different embodiments of the inventive measurement system, wherein a second video signal source is a display of the device under test and the detecting means comprises a camera of the device under test and at least one mirror or one optical wave guide with two optical coupling elements. In the third place, the correlation between device under test sided video quality and radio frequency impairments will be shown by means of the diagram of FIG. 6. Finally, with the aid of the flow chart shown in FIG. 7, the steps of the inventive measurement method will be resumed.

FIG. 1 shows an overview of the measuring of media stream switching, in accordance with example embodiments of the present invention. With reference to FIG. 1, a first video signal source or server 10 provides different media streams 100, 200 and 300. Further, barcodes 111, 211, 311 are added on top of every first video frame 101, 201, 301. Succeeding barcodes are added on top of succeeding video frames, e.g., barcodes 112, 113 on top of video frames 102, 103, barcode 212, 213 on top of video frames 202, 203, and bar codes 312, 313 on top of video frames 302, 303. These barcodes uniquely identify each video frame within one version. Additionally, the barcodes differ between different media streams. Hence, the barcodes uniquely identify the media stream on a video frame by video frame basis. In the example shown in FIG. 1, barcode 111 on frame 101 is used in media stream 100, barcode 211 on frame 201 is used in media stream 200, and barcode 311 on frame 301 is used in media stream 300.

This basic concept of providing different media streams, including different technical versions of the same video content, which are synchronized to each other in order to allow seamless switching between these versions at specific points in the stream, is known as “Adaptive Bitrate Streaming” (ABS). Existing implementations of ABS include, for example, “MPEG-DASH (Dynamic Adaptive Streaming over HTTP),” “HTTP Dynamic Streaming (HDS),” “HTTP Live Streaming (HLS),” and “Microsoft Smooth Streaming.”

In the context of Adaptive Bitrate Streaming, a device under test 1 or client 11 may ask for a specific version of the media stream depending on current operating conditions. The server 10 may then send the requested version to the device under test 1 or client 11.

Further, as the operating conditions may typically change over time, the device under test 1 or client 11 may decide to request another version of the media stream from the server 10. Such operating conditions may include, among others: network conditions, buffer conditions, the make of the device under test 1, user input triggered changes (e.g., switch to full screen, or client sided available resources), etc., which may be based on activities and/or other running applications.

FIG. 2 shows a measuring system where a display and camera of the device under test arranged opposite from each other, in accordance with example embodiments of the present invention. With reference to FIG. 2, the second video signal source is a display 3 of the device under test 1, itself comprising a camera 2. Further, a detecting device comprises four mirrors 4a, 4b, 4c, 4d, which reflect a frame from the display 3 to the camera 2. In this case, the multiple mirrors are employed to reflect the light beam 7 several times, because display 3 and camera 2 are arranged opposite from each other.

FIG. 3 shows a measuring system where a display and camera of the device under test are arranged adjacent to each other, in accordance with example embodiments of the present invention. In this embodiment, because the display and camera are arranged adjacent to each other, only one mirror 4 is employed to reflect the light beam 7, with the result that the frame gets from the display 3 to the camera 2 of the device under test 1.

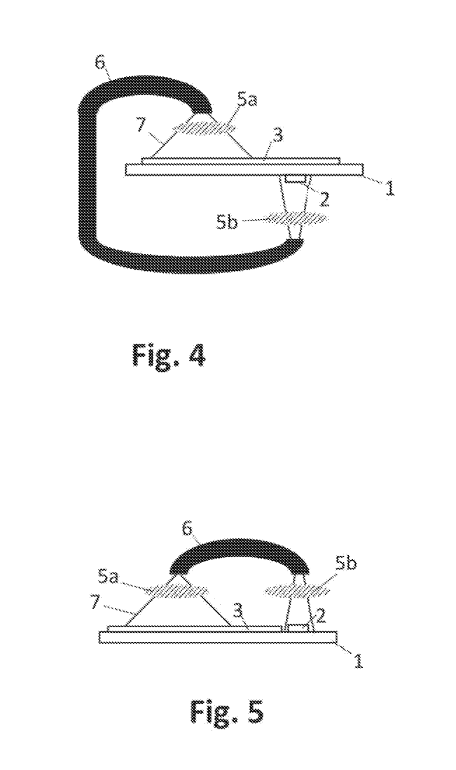

FIG. 4 shows a further measuring system where a display and camera of the device under test are arranged opposite from each other, in accordance with example embodiments of the present invention. With reference to FIG. 4, an optical wave guide 6, with two optical coupling elements or lenses 5a and 5b at each end, is employed (instead of mirrors) to optically transfer the frame from the display 3 of the device under test 1 to its camera 2, which are arranged opposite from each for this embodiment.

FIG. 5 shows a further measuring system where a display and camera of the device under test are arranged adjacent to each other, in accordance with example embodiments of the present invention. With reference to FIG. 5, the optical wave guide 6, with the two optical coupling elements or lenses 5a and 5b at each end, is again employed (instead of mirrors) to optically transfer the frame from the display 3 of the device under test 1 to its camera 2, which are arranged adjacent to each other for this embodiment.

The configurations shown in FIGS. 2-5 can be, but do not need to be, independent from testing the media streams 100, 200 and 300. Using one mirror 4, or several mirrors (e.g., 4a-4d), or using a wave guide 6, can have different applications, where all such applications have in common that a frame or other optical pattern displayed on the display 3 of the device under test 1 should be detected by the camera 2 of the device under test 1.

In accordance with example embodiments, the switching between different versions of a media stream (which is generally hard to capture for human beings) can be measured automatically with the aid of such novel measurement systems, which may be based on the added images with barcodes or other optical or acoustical patterns. For this measurement, a data aggregation and/or processing unit may be employed. Moreover, data aggregation technologies include, on the one hand, external aggregation devices such as a barcode scanner, a camera, a microphone or an external analyzer. External analyzers may be connected either via wired or wireless technologies, such as “High Definition Multimedia Interface” (HDMI), “Mobile High-Definition Link” (MHL) and “Miracast.” On the other hand, an application running on the device under test 1 or client 11 may be employed as an internal data aggregation means of the device under test 1 or client 11. Further, a combination of more than one of the abovementioned options regarding data aggregation is possible.

Additionally, some measurement applications can be implemented based on embodiments of the present invention. By way of example, such applications may include performing measurement if the device under test 1 or client 11 requests a different version (for example, based on operating conditions as discussed above, e.g., with respect to network, buffer, available resources and/or user inputs). By way of further example, such applications may also include influencing the operating conditions and then performing measurement, such as how long it takes until the device under test 1 or client 11 requests a different version of the media stream after the conditions have changed. The device under test 1 may be identical with the client 11.

By way of further example, an additional measurement application may include combined measurement results of the above-mentioned measurement application cases. FIG. 6 illustrates this combination of measurement results. Changes in the radio frequency (RF) layer (e.g., increase of RF impairments 21) may cause impacts in the application layer. It may decrease the video quality 20 on device under test side or client side. This allows for measuring further measurement parameters such as switching delay. This is the delay time between increasing the RF impairment and the decreasing of video quality at the device under test.

FIG. 7 shows a flow chart of a measurement method, in accordance with example embodiments of the present invention. Initially, at Step 30, at least two different technical versions, for example, distinct in video bitrate, audio bitrate, video resolution etc., of the same video content are provided by the server 10. Then, at Step 31, one of the different versions of the video is received and displayed by the device under test 1 or client 11. At Step 32, the device under test 1 or client 11 is made to switch between different versions of the video by changing the operating conditions, for example regarding network, buffer, available resources, user inputs etc. In addition to this, it should be mentioned that making the device under test 1 or client 11 switch between different versions of the video means two things. On the one hand, the device under test 1 or client 11 may be made to switch between different versions of the video by active user input, e.g. changing to full-screen visualization, on the other hand, the device under test 1 or client 11 may be made to switch by influencing the environment parameters such as magnitude of RF impairments 21. In practice, the second alternative is primarily relevant typically to switch between different versions of the video without any active user intervention. At step 33, the currently displayed version of the video is detected and identified by unique optical or acoustical identification pattern of video frames with the aid of data aggregation means of the device under test 1 or client 11 or an external device. Thereafter, at Step 34, measurement parameter(s) regarding the applied application case, for example the switching delay, are determined.

Further, embodiments of the present invention are not limited to the direction of data flow from the first video signal source or server 10 to the device under test 1 or client 11. Data may be also flowing in opposite direction. For instance, a camera 2 in a device under test 1 or client 11 may be recording a video sequence, where the encoding quality may be dynamic according to the network conditions, etc.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. A measurement apparatus for measuring a change, of a device under test, between a first video sequence having a first video quality and a second video sequence having a second video quality, the measurement system comprising:
a video signal source configured to provide the first video sequence and the second video sequence, wherein the first video sequence is identified by a first identification indicator and the second video sequence is identified by a second identification indicator; and
a detecting device configured to detect a change from the first video sequence to the second video sequence based on a difference between the first identification indicator and the second identification indicator; and
wherein a delay time between an increase in radio frequency impairment and a decrease in the first video quality of the device under test is determined.

2. The measurement apparatus of claim 1, wherein each of the first and second identification indicators is one of an optical pattern and an acoustical pattern.

3. The measurement apparatus of claim 2, wherein the optical pattern is one of a bar code and a QR-code, and the acoustic pattern is a sound sequence.

4. The measurement apparatus of claim 1, wherein the detecting device comprises one of a camera and a microphone.

5. The measurement apparatus of claim 1, wherein the detecting device comprises one of a bar code scanner and a QR-code scanner.

6. The measurement apparatus of claim 1, wherein the video signal source comprises a display of the device under test, and wherein the detecting device comprises at least one mirror configured to reflect an image or frame from the display of the device under test to a camera of the device under test, or a light guide configured to guide the image or frame from the display of the device under test to the camera of the device under test.

7. The measurement apparatus of claim 1, wherein the first video sequence and the second video sequence are different media streams.

8. The measurement apparatus of claim 7, wherein the different media streams are versions of a same video content that differ in at least one technical aspect.

9. A measurement method, for measuring a change, of a device under test, between a first video sequence having a first video quality and a second video sequence having a second video quality, the method comprising:
providing, by a video signal source, the first video sequence and the second video sequence, wherein the first video sequence is identified by a first identification indicator and the second video sequence is identified by a second identification indicator;
detecting a change from the first video sequence to the second video sequence based on a difference between the first identification indicator and the second identification indicator; and
determining a delay time between an increase in radio frequency impairment and a decrease in the first video quality of the device under test.

10. The measurement method of claim 9, wherein each of the first and second identification indicators is one of an optical pattern and an acoustical pattern.

11. The measurement method of claim 10, wherein the optical pattern is one of a bar code and a QR-code, and the acoustic pattern is a sound sequence.

12. The measurement method of claim 9, wherein the video signal source comprises a display of the device under test, and wherein an image or frame of the display is reflected or guided from the display to a camera of the device under test.

13. The measurement method of claim 9, wherein the first video sequence and the second video sequence are different media streams.

14. The measurement method of claim 13, wherein the different media streams are versions of a same video content that differ in at least one technical aspect.

15. The measurement method of claim 9, wherein the change from the first video sequence to the second video sequence is based on a change in video quality, and wherein a time delay between the change in video quality and a reaction of the device under test is measured.

16. A measurement system comprising:
a device under test comprising an optical display and an optical detector; and
one of (i) at least one mirror configured to reflect an image or frame from the optical display to the optical detector, and (ii) at least one light guide configured to guide the image or frame from the optical display to the optical detector; and
wherein a delay time between an increase in radio frequency impairment and a decrease in video quality of the image or frame of the device under test is determined.

17. The measurement system of claim 16, wherein the optical detector comprises a camera.

18. The measurement system of claim 16, wherein the light guide comprises an optical wave guide.

19. The measurement system of claim 18, wherein the light guide further comprises a first lens that focuses the image or frame from the optical display to a first end of the optical wave guide, and a second lens that focuses the image or frame from a second end of the optical wave guide to the optical detector.

20. The measurement system of claim 16, wherein the image or frame comprises a predefined test pattern.
